(19) United States
(12) Patent Application Publication
(10) Pub. No.: US 2017/0089413 A1
(43) Pub. Date: Mar. 30, 2017

(54) CONTROL SYSTEM FOR MANUAL TRANSMISSIONS

(71) Applicant: BorgWarner Inc., Auburn Hills, MI (US)

(72) Inventors: Michael SCHWEKUTSCH, Palo Alto, CA (US); Mark BUCHANAN, Rochester Hills, MI (US)

(21) Appl. No.: 15/315,833

(22) PCT Filed: May 29, 2015
(86) PCT No.: PCT/US2015/033127

§ 371 Date: Dec. 2, 2016

Related U.S. Application Data
(60) Provisional application No. 62/010,844, filed on Jun. 11, 2014.

(51) Int. Cl. F16D 48/06; F16H 63/46

(52) U.S. Cl. CPC F16D 48/068; F16H 63/46; F16D 2121/04

(57) ABSTRACT

A control system (44) for a clutch (18) of a manual transmission (16) in a vehicle (10) having an ECU (22), an engine (14), a pedal (26) having a sensor (42), a slave (34) in fluid communication with a master (36); and at least one input (24). The control system (44) includes a pump (50), a valve (52) in fluid communication with the slave (34) and pump (50), and a controller (46) responsive to the ECU (22) and operable in a plurality of modes for selectively cooperating with the pedal (26) to actuate the slave (34) and modulate the clutch (18) under predetermined engine (14) and vehicle (10) operating conditions. The controller (46) is movable between modes in response to signals from the ECU (22) representing predetermined changes in one or more of: engine speed, engine load, vehicle speed, transmission gear, pedal position, or input state.

### BACKGROUND OF INVENTION

1. Field of Invention

The present invention relates generally to automotive transmission systems and, more specifically, to a control system for manual transmissions.

2. Description of the Related Art

Conventional automotive powertrain systems that utilize manual transmissions known in the art typically include an internal combustion engine having a crankshaft in selective rotational communication with the manual transmission, a clutch assembly, and a hydraulic actuation system. The clutch assembly is used to selectively modulate engagement between the engine and transmission. To that end, the clutch assembly typically includes a flywheel operatively attached to the crankshaft, a pressure plate in rotational communication with an input shaft of the transmission and operatively attached to the flywheel, and a clutch disk disposed between the flywheel and the pressure plate. The hydraulic actuation system typically includes a master cylinder in fluid communication with a slave cylinder. The slave cylinder is actuated by a clutch pedal and, in turn, actuates the master cylinder, which then operatively engages the pressure plate so as to modulate the clutch assembly and, thus, the engagement between the engine and transmission.

There are several types of transmissions for use in automotive powertrain systems known in the art. As such, control systems for transmissions vary widely depending on the type of transmission. By way of example, conventional automatic transmissions typically utilize a torque converter, hydraulic fluid, and solenoid valves, whereby a transmission computer or engine control unit actuates the solenoid valves to shift through gears without operator input, whereas conventional “dry clutch” manual transmissions (as described above) require the vehicle operator to actuate the clutch pedal and a shift lever to shift through gears. In comparison to automatic transmissions, however, conventional manual transmissions have fewer parts and are more efficient in terms of parasitic loss, which typically translates to lower vehicle weight and increased fuel economy. Other so-called semi-automatic transmission types known in the art (such as dual-clutch, continuously-variable, and direct-shift-gearbox types, for example) attempt to balance the efficiency of manual transmissions with the convenience of automatic transmissions. However, these transmissions are typically complex, expensive to manufacture, heavy, difficult to service, and frequently perform poorly in stop-and-go traffic. Further, these transmissions are typically controlled entirely electronically and, as a result, no clutch pedal is typically utilized, which is undesirable to operators who enjoy using a clutch pedal and having control over modulating the engagement between the engine and transmission. Moreover, the control systems for these transmissions are complex and, as discussed above, are still unable to provide the low-speed drivability of automatic transmissions as well as the high efficiency of manual transmissions.

Each of the components of a manual transmission powertrain system of the type described above must cooperate to effectively modulate engagement between the engine and transmission. In addition, each of the components must be designed not only to facilitate improved performance and efficiency, but also so as to reduce the cost and complexity of manufacturing and assembling the system. While manual transmission powertrain systems known in the related art have generally performed well for their intended purpose, there remains a need in the art for a control system for manual transmissions that provides superior low-speed drivability and enhanced operational characteristics while, at the same time, allowing an operator the privilege of using a clutch pedal if desired.

### SUMMARY OF THE INVENTION

The present invention overcomes the disadvantages in the related art in a control system for use in modulating a clutch of a manual transmission in a vehicle. The vehicle has an engine control unit, an engine in selective rotational communication with the transmission, and a clutch pedal movable by an operator. The clutch pedal has a position sensor in electrical communication with the engine control unit. The vehicle also has a slave cylinder in communication with the clutch for modulating the engagement between the transmission and the engine, and a master cylinder in fluid communication with the slave cylinder and operatively attached to the clutch pedal. The vehicle also has at least one input control in electrical communication with the engine control unit and adapted to be triggered by the operator. The control system of the present invention includes a pump for generating hydraulic pressure, a valve in fluid communication with the slave cylinder and the pump, and a controller in communication with the valve for modulating the same. The controller is responsive to signals from the engine control unit and is operable in one or more of seven modes. In the first mode, the valve is modulated such that the master cylinder alone actuates the slave cylinder to modulate the clutch. In the second mode, the valve is modulated from engine startup so as to actuate the slave cylinder to modulate the clutch so as to decouple the engine from the transmission. In the third mode, the valve is modulated during engine idle with the vehicle stopped so as to actuate the slave cylinder to modulate the clutch so as to decouple the engine from the transmission. In the fourth mode, the valve is modulated from engine idle, with the vehicle stopped, and with the transmission in gear so as to actuate the slave cylinder to modulate the clutch at a predetermined rate so as to simultaneously couple the engine to the transmission, prevent the engine from stalling, and prevent the vehicle from reversing. In the fifth mode, the valve is modulated from engine idle, with the vehicle stopped, with the transmission in gear, and during acceleration so as to actuate the slave cylinder to modulate the clutch at a predetermined rate so as to simultaneously couple the engine to the transmission and prevent the engine from stalling. In the sixth mode, the valve is modulated during vehicle movement with the transmission in gear so as to actuate the slave cylinder to modulate the clutch so as to decouple the engine from the transmission. In the seventh mode, the valve is modulated during vehicle deceleration with the transmission in gear so as to actuate the slave cylinder to modulate the clutch so as to decouple the engine from the transmission. The controller is movable between the modes in response to signals from the engine control unit representing predetermined changes in one or more of: engine speed, engine load, vehicle speed, transmission gear, clutch pedal position, or input control state.

In addition, the present invention is directed toward a control system for use in modulating a clutch of a manual transmission in a vehicle. The vehicle has an engine in selective rotational communication with the transmission, a clutch pedal in communication with the clutch and movable by a vehicle operator for selectively modulating the engagement between the transmission and the engine, and an actuator in communication with the clutch for modulating the engagement between the transmission and the engine independent of the clutch pedal. The control system of the present invention includes a controller a controller in communication with the actuator for driving the actuator. The controller is operable in one or more of seven modes. In the first mode, the actuator is driven such that the clutch pedal alone modulates the clutch. In the second mode, the actuator is driven from engine startup so as to modulate the clutch to decouple the engine from the transmission. In the third mode, the actuator is driven during engine idle with the vehicle stopped so as to modulate the clutch to decouple the engine from the transmission. In the fourth mode, the actuator is driven from engine idle, with the vehicle stopped, and with the transmission in a forward gear so as modulate the clutch at a predetermined rate to simultaneously couple the engine to the transmission, prevent the engine from stalling, and prevent the vehicle from reversing. In the fifth mode, the actuator is driven from engine idle, with the vehicle stopped, with the transmission in a forward gear, and during acceleration so as to modulate the clutch at a predetermined rate to simultaneously couple the engine to the transmission and prevent the engine from stalling. In the sixth mode, the actuator is driven during vehicle movement with the transmission in a forward gear so as to modulate the clutch to decouple the engine from the transmission. In the seventh mode, the actuator is driven during vehicle deceleration with the transmission in a forward gear so as to modulate the clutch to decouple the engine from the transmission. The controller is movable between the modes in response to predetermined changes in one or more of: engine speed, engine load, vehicle speed, transmission gear, or clutch pedal position.

Further, the present invention is directed toward a control system for use in modulating a clutch of a manual transmission in a vehicle. The vehicle has an engine in selective rotational communication with the transmission, a clutch pedal in communication with the clutch and movable by a vehicle operator for selectively modulating the engagement between the transmission and the engine, an actuator in communication with the clutch for modulating the engagement between the transmission and the engine independent of the clutch pedal, and an authority level control and adapted to be triggered by the vehicle operator. The control system of the present invention includes a controller communication with the actuator for driving the same. The controller is operable at a plurality of authority levels, from level zero to level three. At authority level zero, the controller operates in a first mode wherein the actuator is driven such that the clutch pedal alone modulates the clutch. At authority level one, the controller operates in one or more of a second, third, fourth, or fifth mode. In the second mode, the actuator is driven from engine startup so as to modulate the clutch to decouple the engine from the transmission. In the third mode, the actuator is driven during engine idle with the vehicle stopped so as to modulate the clutch to decouple the engine from the transmission. In the fourth mode, the actuator is driven from engine idle, with the vehicle stopped, and with the transmission in a forward gear so as modulate the clutch at a predetermined rate to simultaneously couple the engine to the transmission, prevent the engine from stalling, and prevent the vehicle from reversing. In the fifth mode, the actuator is driven from engine idle, with the vehicle stopped, with the transmission in a forward gear, and during acceleration so as to modulate the clutch at a predetermined rate to simultaneously couple the engine to the transmission and prevent the engine from stalling. At authority level two, the controller operates in one or more of a sixth or seventh mode. In the sixth mode, the actuator is driven during vehicle movement with the transmission in a forward gear so as to modulate the clutch to decouple the engine from the transmission. In the seventh mode, the actuator is driven during vehicle deceleration with the transmission in a forward gear so as to modulate the clutch to decouple the engine from the transmission. At authority level three, the controller operates in one or more of the first, sixth, or seventh mode. The controller is movable between the authority levels in response to one of changes to the authority level control, and predetermined changes in one or more of: engine speed, engine load, vehicle speed, transmission gear, or clutch pedal position.

In this way, the present invention significantly improves the operation, functionality, and drivability of vehicles with conventional manual transmissions. Moreover, the present invention enables advantages related to clutch and transmission protection and longevity. Further, the present invention allows a vehicle operator to drive a manual transmission equipped vehicle in stop-and-go traffic without actuating the clutch pedal. Furthermore, the present invention reduces the cost and complexity of manufacturing automotive powertrain systems that have superior operational characteristics such as high efficiency, low weight, increased control capability, and improved functionality.

### BRIEF DESCRIPTION OF THE DRAWINGS

Other objects, features, and advantages of the present invention will be readily appreciated as the same becomes better understood after reading the subsequent description taken in connection with the accompanying drawing wherein:

FIG. 1 is a partial exploded perspective view of a conventional automotive powertrain with a manual transmission.

FIG. 2 is partial enlarged side plan view of a control system for a manual transmission according to one embodiment of the present invention.

### DETAILED DESCRIPTION OF THE INVENTION

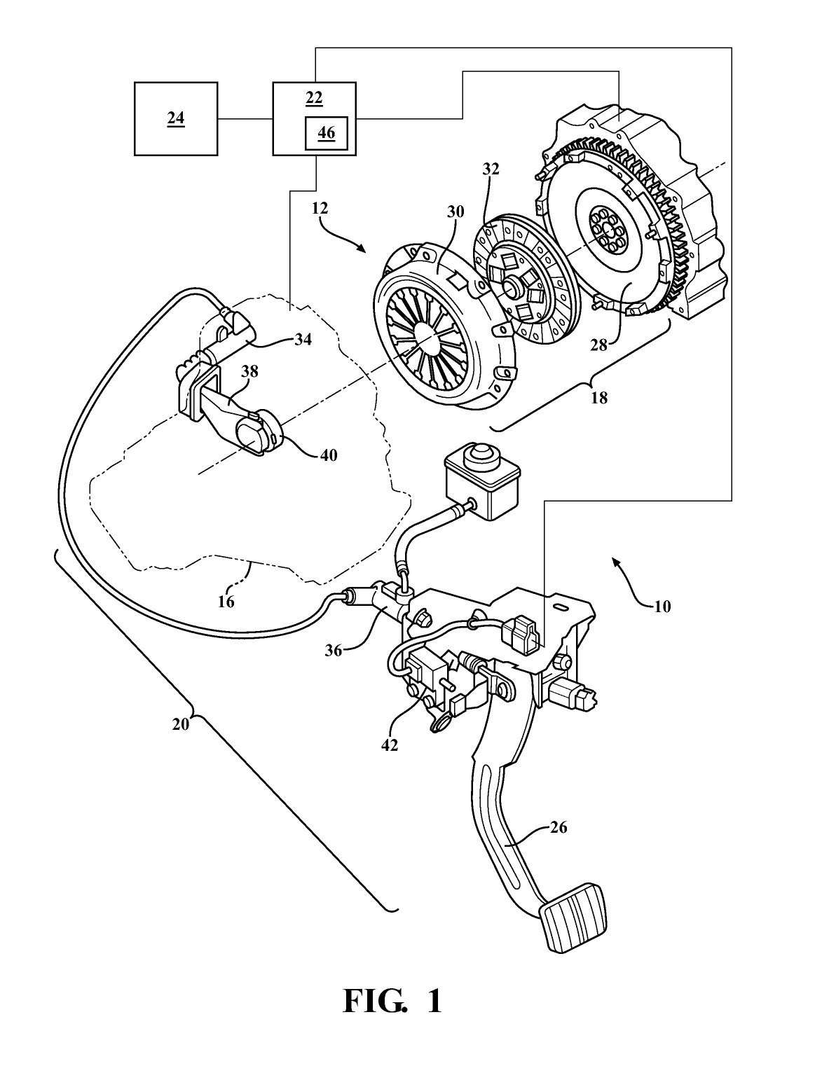

Referring now to the figures, where like numerals are used to designate like structure, a portion of a conventional automotive vehicle is generally indicated at 10 in FIG. 1. The vehicle 10 includes a powertrain 12 for propelling the vehicle. The powertrain 12 generally includes an engine 14, manual transmission 16, and clutch assembly 18. The vehicle 10 may also include a clutch actuation system, generally indicated at 20, an engine control unit (ECU) 22, and one or more input controls 24. Each of these components will be discussed in greater detail below.

The engine 14 generates rotational torque, which is selectively translated via the engine crankshaft (not shown, but generally known in the art) to the transmission 16 so as to drive the vehicle 10, as discussed in greater detail below. The engine 14 shown in FIG. 1 is typically a spark-ignition Otto-cycle engine 14, which is controlled by the ECU 22. However, those having ordinary skill in the art will appreciate that the engine 14 could be of any suitable configuration, controlled using any thermodynamic cycle and in any suitable way, without departing from the scope of the present invention. Moreover, it will be appreciated that the engine 14 could be of any type suitable to generate rotational torque without departing from the scope of the present invention. By way of non-limiting example, the engine 14 could be a conventional internal combustion engine, a hybrid engine with an internal combustion engine and an electric motor, or a standalone electric motor.

The transmission 16 is a conventional manual transmission 16 and includes a plurality of gears (not shown, but generally known in the art) rotationally supported therein. The gears are changed (or “shifted”) by the vehicle operator. To that end, a shift lever (not shown, but generally known in the art) is typically used in connection with a clutch pedal 26 to change between gears, wherein the shift lever is operatively connected to the transmission 16 such that movement of the shift lever between predetermined shifter locations correspondingly moves the transmission 16 gears between predetermined ratios, such as reverse, first gear, second gear, and the like. The clutch pedal 26 is movable by the vehicle operator and is used to modulate the clutch 18 to selectively control the engagement between the engine 14 and the transmission 16, as discussed in greater detail below.

The clutch assembly 18 includes a flywheel 28 operatively attached to the crankshaft, a pressure plate 30 operatively attached to the flywheel 28 and in rotational communication with the transmission 16, and a clutch disc 32 disposed between the flywheel 28 and pressure plate 30. The clutch assembly 18 shown in FIG. 1 is a conventional dry clutch and is well known in the art. However, it will be appreciated that the clutch assembly 18 could have any suitable configuration or arrangement sufficient to operatively attach to the engine 14 crankshaft and adapted to modulate the engagement between the engine 14 and transmission, without departing from the scope of the present invention.

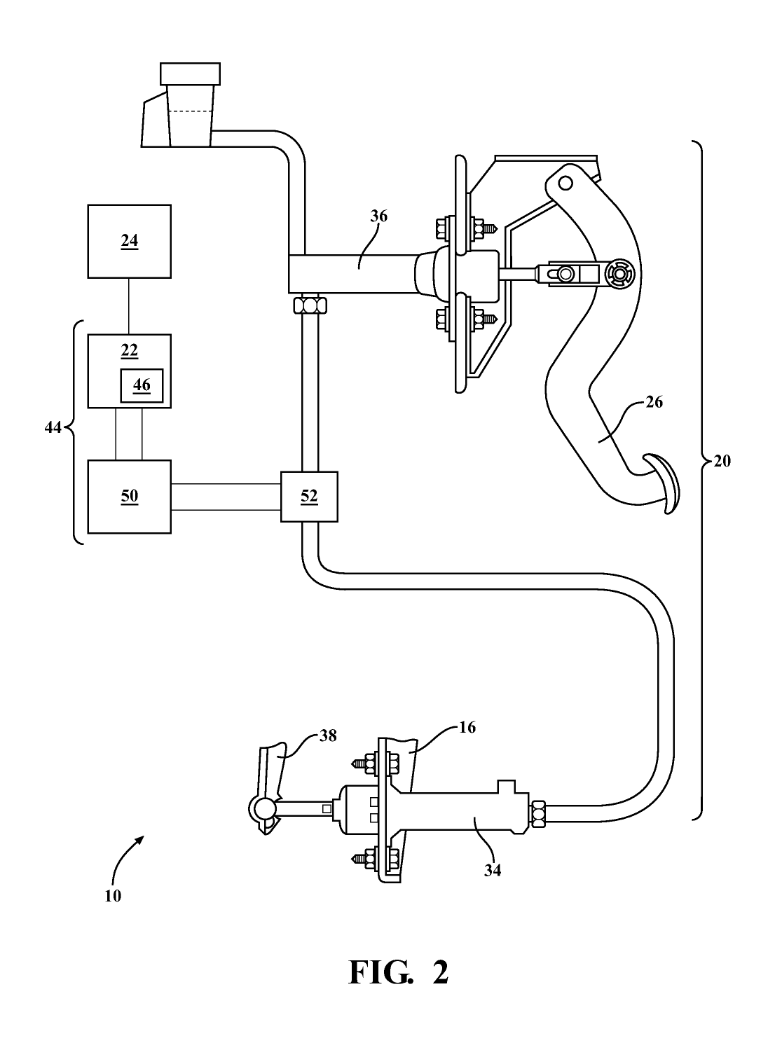

As discussed above, the vehicle 10 also includes a clutch actuation system 20. The clutch actuation system 20 is used to enable the vehicle operator to modulate the clutch 18 and control the engagement between the engine 14 and the transmission 16. As shown in FIGS. 1 and 2, the clutch actuation system 20 typically includes a slave cylinder 34 in fluid communication with a master cylinder 36. The master cylinder 36 is operatively attached to the clutch pedal 26 such that the when the vehicle operator actuates the clutch pedal 26, the master cylinder moves hydraulic fluid to the slave cylinder 34, as discussed in greater detail below. Those having ordinary skill in the art will recognize that this as a conventional hydraulic clutch system.

The slave cylinder 34 is in communication with the clutch 18 and is used to modulate the engagement between the transmission 16 and the engine 14. To that end, the slave cylinder 34 is typically mounted to the transmission 16 or engine 14 and actuates a clutch fork 38, which subsequently presses a throw-out bearing 40 against the pressure plate 30 of the clutch 18 so as to decouple the engine 14 from the transmission 16. However, those having ordinary skill in the art will appreciate that the slave cylinder 34 could be in communication with the clutch 18 in any suitable way without departing from the scope of the present invention. Moreover, it will be appreciated that the clutch actuation system 20 could be of any type suitable to enable the vehicle operator to modulate the clutch 18 and control the engagement between the engine 14 and the transmission 16, be it hydraulic or otherwise, without departing from the scope of the present invention.

As discussed above, the vehicle 10 typically includes an ECU 22 used to control the injection of fuel and the ignition of the air/fuel mixture inside the engine 14. The ECU 22 is also typically in electrical communication with a plurality of sensors (not shown, but generally known in the art) arranged throughout the powertrain 12 and vehicle 10 in general. Sensors provide the ECU 22 with information used to control, regulate, or otherwise alter the performance of the engine 14 and/or vehicle 10. By way of example, a clutch position sensor 42 (see FIG. 1) in communication with the clutch pedal 26 and in electrical communication with the ECU 22 could be used to determine the physical position of the clutch pedal 26 in operation. Moreover, the ECU 22 could use signals received from the clutch position sensor 42, or any suitable sensor, to determine iterative or derivative information of the signal (such as the rate of change of the position of the clutch pedal), and could alter the performance of the engine 14 or other systems accordingly, as discussed in greater detail below.

As discussed above, the vehicle 10 also typically includes at least one input control 24. Like the sensors discussed above, input controls 24 are in electrical communication with the ECU 22. Input controls 24 are adapted to be triggered by the operator and could be of any suitable form, configuration, or type. By way of non-limiting example, input controls could be formed as buttons, switches, sensors, or software algorithms executed by the ECU 22 or otherwise without intervention of the vehicle operator, without departing from the scope of the present invention. As discussed in greater detail below, the ECU 22 is responsive to changes in state of the input controls 24.

Referring now to FIG. 2, the present invention is directed toward a control system, generally indicated at 40. The control system 44 modulates the clutch 18 of the manual transmission 16 in the vehicle 10 to cooperate with the vehicle operator and to enhance vehicle performance, functionality, and convenience. The control system 44 includes a controller 46 and, in one embodiment, may also include an actuator, generally indicated at 44 in communication with the controller 46. These components are discussed in greater detail below.

The controller 46 drives the actuator 48 so as to modulate the engagement between the transmission 16 and the engine 14 independent of the clutch pedal 26, as discussed in greater detail below. The controller 46 may be responsive to signals from the ECU 22 and is in communication with the actuator 48. More specifically, and as shown in FIGS. 1 and 2, the controller 46 may be integrated with the ECU 22. By way of non-limiting example, the controller 46 could be integrated with the ECU 22 as a subroutine, command, control loop, or any other suitable software code, on either common or independent processor, memory, storage, or the like. Moreover, it is conceivable that the controller 46 could be altogether independent of and in communication with the ECU 22, without departing from the scope of the present invention and wherein the ECU 22 itself would form no part of the present invention.

The present invention may also include an actuator 48. However, as will be appreciated from the discussion below, the actuator 48 could be implemented as a component of the vehicle 10 rather than as a component of the control system 44 of the present invention. Moreover, it will be appreciated that no components, portions, or systems of the vehicle 10 form part of the present invention—the present invention is directed toward the control system 44 that interacts with the vehicle 10 as described herein. As shown in FIG. 2, in one embodiment, the actuator 48 includes a pump 50 and a valve 52. The pump 50 is used to generate hydraulic pressure. The valve 52 is in fluid communication with the slave cylinder 34 and the pump 50, and is in communication with the controller 46. The valve 52 is adapted to be modulated by the controller 46 so as to actuate the slave cylinder 34 and subsequently modulate the clutch 18. As illustrated in FIG. 2, the valve 52 is a two-way valve 52 disposed between the master cylinder 36 and the slave cylinder 34. It will be appreciated that the arrangement of the pump 50, valve 52, slave cylinder 34, and master cylinder 36 defines a hydraulic system wherein the slave cylinder 34 is actuated by whichever of the master cylinder 36 and pump 50 provides higher pressure. Thus, it will be appreciated that the pump could be driven at higher pressures than the master cylinder 36 is capable of producing, so as to mechanically override the clutch pedal 26. Further, while the pump 50 and valve 52 are shown in FIG. 2 as being spaced from each other, those having ordinary skill in the art will appreciate that the pump 50 and valve 52 could be formed together without departing from the scope of the present invention. Moreover, it is conceivable that the pump 50, valve 52, and slave cylinder 34 could be formed together.

It will be appreciated that the actuator 48 could be of any suitable type, style, or design without departing from the scope of the present invention. Specifically, it is conceivable that the actuator 48 could be designed without a valve 52 as described above . Thus, for purposes of clarity, all subsequent discussion of the interaction of the controller 46 and the clutch actuation system 20 will be with respect to modulation of the actuator 48, rather than modulation of the valve 52.

As discussed in greater detail below, the controller 46 is operable in one or more modes defined by predetermined vehicle 10 conditions. Specifically, the controller 46 of the present invention is movable between a total of seven modes in response to predetermined changes in one or more of: engine 14 speed, engine 14 load, vehicle 10 speed, transmission 16 gear, clutch pedal 26 position, or input control 24 state. Each of the seven modes will be discussed in greater detail below.

In the first mode, the controller 46 modulates the actuator 48 such that the master cylinder 36 alone actuates the slave cylinder 34 to modulate the clutch 18. It will be appreciated that this is an “off” mode. Further, in one embodiment, the input controls 24 include a clutch assist control, wherein the controller 46 moves to the first mode in response to a change in the state of the clutch assist control. Thus, it will be appreciated that the first mode can allow the vehicle operator to disable subsequent intervention of the controller 46, such that the vehicle 10 can be driven as if it had a conventional manual transmission 16 without a clutch 18 control system 44 of the present invention. Moreover, in one embodiment, the vehicle 10 may include a throttle pedal and a brake pedal (not shown, but generally known in the art) each being movable by the vehicle operator and each having position sensors in electrical communication with the ECU 22, wherein the controller 46 moves to the first mode in response to a predetermined change in one or more of: clutch pedal 26 position, brake pedal position, or throttle pedal position. Thus, it will be appreciated that the controller 46 can be brought to the first mode simply by the vehicle operator actuating the pedals, if necessary. Further, as discussed above, in one embodiment, the controller 46 can move to the first mode in response to a predetermined pressure differential occurring between the pump 50 and the master cylinder 36.

In the second mode, the controller 46 modulates the actuator 48 from engine 14 startup so as to actuate the slave cylinder 34 to modulate the clutch 18 so to decouple the engine 14 from the transmission 16. Further, in one embodiment, the input controls 24 include an engine start control, such as an ignition switch or an engine start button, wherein the controller 46 moves to the second mode in response to a change in the state of the engine start control where the transmission 16 is in gear and the clutch pedal 26 is up. Thus, it will be appreciated that the second mode can allow the vehicle 10 to prevent the engine 14 lurching forward if the transmission 16 is left in gear, whereby the controller 46 avoids lurching but still enables engine 14 starting by actuating the slave cylinder 34.

In the third mode, the controller 46 modulates the actuator 48 during engine 14 idle with the vehicle 10 stopped so as to actuate the slave cylinder 34 to modulate the clutch 18 so as to decouple the engine 14 from the transmission 16. Thus, it will be appreciated that the third mode can be used in connection with so-called start-stop engine technology to save gas at idle by shutting the engine 14 off while the vehicle 10 is stopped. Further, as will be appreciated from the description of subsequent modes, the third mode can cooperate with other modes to allow the vehicle 10 to be driven with the transmission 16 left in first gear, in stop-and-go traffic, without necessitating the use of the clutch pedal 26 by the vehicle operator. Moreover, in one embodiment, the controller 46 moves to the third mode from the second mode in response to the engine 14 reaching a predetermined speed. Thus, it will be appreciated that moving from the second mode to the third mode enables the vehicle operator bring the vehicle 10 to a stop without actuating the clutch pedal 16 and without stalling the engine 14.

In the fourth mode, the controller 46 modulates the actuator 48 from engine 14 idle, with the vehicle 10 stopped, and with the transmission 16 in gear so as to actuate the slave cylinder 34 to modulate the clutch 18 at a predetermined rate so as to simultaneously couple the engine 14 to the transmission 16, prevent the engine 14 from stalling, and prevent the vehicle 10 from reversing. Further, in one embodiment, the input controls 24 include a hill assist control, wherein the controller 46 moves to the fourth mode in response to a change in the state of the hill assist control. Thus, it will be appreciated that the fourth mode can be utilized so as to prevent reverse movement of the vehicle 10 during a hill start. Specifically, it is conceivable that the forth mode could cooperate with the use of the clutch pedal 26 by the vehicle operator to effect smooth, forward movement of the vehicle 10. Moreover, in one embodiment, the controller 46 moves to the fourth mode from the third mode in response to the transmission 16 moving from a neutral position to a forward gear. Thus, it will be appreciated that moving from the third mode to the fourth mode enables the vehicle operator to prevent reverse movement of the vehicle 10 without actuating the clutch pedal 16 and without stalling the engine 14 when coasting the vehicle 10 to a stop and placing the transmission 16 in gear.

In the fifth mode, the controller 46 modulates the actuator 48 from engine 14 idle, with the vehicle 10 stopped, with the transmission 16 in gear, and during acceleration of the vehicle 10 so as to actuate the slave cylinder 34 to modulate the clutch 18 at a predetermined rate so as to simultaneously couple the engine 14 to the transmission 16 and prevent the engine 14 from stalling. Further, in one embodiment, the input controls 24 include a launch, wherein the controller 46 moves to the fifth mode in response to a change in the state of the launch control. Thus, it will be appreciated that the fifth mode can be utilized so as optimize acceleration or “launch” of the vehicle 10, such that the vehicle operator need only put the transmission 16 in first gear, and actuate the throttle and brake pedals, such that the ECU 22 could subsequently hold the engine 14 to a predetermined speed and, once the vehicle operator releases the brake pedal, the ECU 22 could cooperate with the fifth mode of the controller 46 so as to modulate the clutch 18 without the use of the clutch pedal 26 by the vehicle operator, so as to effect ideal forward acceleration of the vehicle 10. It will be appreciated that the ECU 22 and controller 46 could interact in different ways and that the vehicle 10 could launch with a different process without departing from the scope of the present invention.

In the sixth mode, the controller 46 modulates the actuator 48 during vehicle 10 movement with the transmission 16 in gear so as to actuate the slave cylinder 34 to modulate the clutch 18 so as to decouple the engine 14 from the transmission 16. Further, in one embodiment, the controller 46 moves to the sixth mode in response to a predetermined change in one or more of: vehicle 10 speed, engine 14 speed, or engine 14 load. Thus, it will be appreciated that the sixth mode can effect what is referred to in the art as “sailing,” wherein predetermined driving conditions enable the vehicle 10 to maintain a specific speed without necessitating torque from the engine 14, wherein the controller 46 can decouple the engine 14 from the transmission 16 so as to lower the engine 14 operating speed and, thus, improve fuel economy during coasting.

In the seventh mode, the controller 46 modulates the actuator 48 during vehicle 10 deceleration with the transmission 16 in gear so as to actuate the slave cylinder 34 to modulate the clutch 18 so as to decouple the engine 14 from the transmission 16. Further, in one embodiment, the controller 46 moves to the seventh mode in response to a predetermined change in one or more of: vehicle 10 speed, engine 14 speed, or engine 14 load. Thus, it will be appreciated that the sixth mode can enable the vehicle 10 to conserve fuel when coming to a stop, whereby the controller 46 can decouple the engine 14 from the transmission 16 so as to lower the engine 14 operating speed and, thus, improve fuel economy during deceleration.

Further, in one embodiment, the input controls 24 include an authority level control, with the controller 46 being operable at different authority levels in response to changes in the state of the authority level control, wherein the authority levels represent the relative amount of intervention or cooperation by the controller 46 in modulating the clutch 18. Specifically, the controller 46 may operated at four different authority levels; zero, one, two, and three. The controller 46 is movable between the authority levels in response to one of changes in the authority level control, and predetermined changes in one or more of: engine 14 speed, engine 14 load, vehicle 10 speed, transmission 16 gear, or clutch pedal 26 position. At authority level zero, the controller 46 is operable in the first mode, as discussed above. At authority level one, the controller 46 is operable in one or more of the second, third, fourth, and fifth modes, as discussed above. At authority level two, the controller 46 is operable in one or more of the sixth and seventh modes, as discussed above. At authority level three, the controller 46 is operable in one or more of the first, sixth, or seventh modes, as discussed above.

In this way, the control system 44 of the present invention significantly improves the operation, functionality, and drivability of vehicles 10 equipped with conventional manual transmissions 16. Moreover, the present invention enables advantages related to clutch 18 and transmission 16 protection and longevity. Further, the present invention allows a vehicle operator to drive a vehicle 10 equipped with a manual transmission 16 in stop-and-go traffic without actuating the clutch pedal 26. Furthermore, the present invention reduces the cost and complexity of manufacturing automotive powertrain 12 systems that have superior operational characteristics such as high efficiency, low weight, increased control capability, and improved functionality.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

What is claimed is:

1. A control system (44) for use in modulating a clutch (18) of a manual transmission (16) in a vehicle (10), wherein the vehicle (10) has an engine control unit (22); an engine (14) in selective rotational communication with the transmission (16); a clutch pedal (26) movable by an operator and having a position sensor (42) in electrical communication with the engine control unit (22); a slave cylinder (34) in communication with the clutch (18) for modulating the engagement between the transmission (16) and the engine (14); a master cylinder (36) in fluid communication with the slave cylinder (34) and operatively attached to the clutch pedal (26); and at least one input control (24) in electrical communication with the engine control unit (22) adapted to be triggered by the operator, said control system (44) comprising:
a pump (50) for generating hydraulic pressure;
a valve (52) in fluid communication with the slave cylinder (34) and said pump (50); and
a controller (46) in communication with the valve (52) for modulating the same, said controller (46) being responsive to signals from the engine control unit (22) and operable in one or more of:
a first mode wherein the valve (52) is modulated such that the master cylinder (36) alone actuates the slave cylinder (34) to modulate the clutch (18);
a second mode wherein the valve (52) is modulated from engine (14) startup so as to actuate the slave cylinder (34) to modulate the clutch (18) so as to decouple the engine (14) from the transmission (16);
a third mode wherein the valve (52) is modulated during engine (14) idle with the vehicle (10) stopped so as to actuate the slave cylinder (34) to modulate the clutch (18) so as to decouple the engine (14) from the transmission (16);
a fourth mode wherein the valve (52) is modulated from engine (14) idle, with the vehicle (10) stopped, and with the transmission (16) in gear so as to actuate the slave cylinder (34) to modulate the clutch (18) at a predetermined rate so as to simultaneously couple the engine (14) to the transmission (16), prevent the engine (14) from stalling, and prevent the vehicle (10) from reversing;
a fifth mode wherein the valve (52) is modulated from engine (14) idle, with the vehicle (10) stopped, with the transmission (16) in gear, and during acceleration so as to actuate the slave cylinder (34) to modulate the clutch (18) at a predetermined rate so as to simultaneously couple the engine (14) to the transmission (16) and prevent the engine (14) from stalling;
a sixth mode wherein the valve (52) is modulated during vehicle (10) movement with the transmission (16) in gear so as to actuate the slave cylinder (34) to modulate the clutch (18) so as to decouple the engine (14) from the transmission (16); or
a seventh mode wherein the valve (52) is modulated during vehicle (10) deceleration with the transmission (16) in gear so as to actuate the slave cylinder (34) to modulate the clutch (18) so as to decouple the engine (14) from the transmission (16),
said controller (46) being movable between said modes in response to signals from the engine control unit (22) representing predetermined changes in one or more of: engine speed, engine load, vehicle speed, transmission gear, clutch pedal position, or input control (24) state.

2. The control system (44) as set forth in claim 1, wherein the input control (24) includes a clutch assist control, and
wherein said controller (46) moves to said first mode in response to a change in the state of the clutch assist control.

3. The control system (44) as set forth in claim 1, wherein the input control (24) includes an engine start control, and
wherein said controller (46) moves to said second mode in response to a change in the state of the engine start control with the transmission (16) being in a gear and the clutch pedal (26) being in an up position.

4. The control system (44) as set forth in claim 1, wherein the input control (24) includes a hill assist control, and
wherein said controller (46) moves to said fourth mode in response to a change in the state of the hill assist control.

5. The control system (44) as set forth in claim 1, wherein the input control (24) includes a launch control, and
wherein said controller (46) moves to said fifth mode in response to a change in the state of the launch control.

6. The control system (44) as set forth in claim 1, wherein the vehicle (10) further includes a throttle pedal and brake pedal each being movable by an operator and each having position sensors in electrical communication with the engine control unit (22), and
wherein said controller (46) moves to the first mode in response to a predetermined change in one or more of: clutch pedal position, brake pedal position, or throttle pedal position.

7. A control system (44) for use in modulating a clutch (18) of a manual transmission (16) in a vehicle (10), wherein the vehicle (10) has an engine (14) in selective rotational communication with the transmission (16); a clutch pedal (26) in communication with the clutch (18) and movable by a vehicle (10) operator for selectively modulating the engagement between the transmission (16) and the engine (14); and an actuator (48) in communication with the clutch (18) for modulating the engagement between the transmission (16) and the engine (14) independent of the clutch pedal (26), said control system (44) comprising:
a controller (46) in communication with the actuator (48) for driving the same, said controller (46) being operable in one or more of:
a first mode wherein the actuator (48) is driven such that the clutch pedal (26) alone modulates the clutch (18);
a second mode wherein the actuator (48) is driven from engine (14) startup so as to modulate the clutch (18) to decouple the engine (14) from the transmission (16);
a third mode wherein the actuator (48) is driven during engine (14) idle with the vehicle (10) stopped so as to modulate the clutch (18) to decouple the engine (14) from the transmission (16);
a fourth mode wherein the actuator (48) is driven from engine (14) idle, with the vehicle (10) stopped, and with the transmission (16) in a forward gear so as modulate the clutch (18) at a predetermined rate to simultaneously couple the engine (14) to the transmission (16), prevent the engine (14) from stalling, and prevent the vehicle (10) from reversing;
a fifth mode wherein the actuator (48) is driven from engine (14) idle, with the vehicle (10) stopped, with the transmission (16) in a forward gear, and during acceleration so as to modulate the clutch (18) at a predetermined rate to simultaneously couple the engine (14) to the transmission (16) and prevent the engine (14) from stalling;
a sixth mode wherein the actuator (48) is driven during vehicle (10) movement with the transmission (16) in a forward gear so as to modulate the clutch (18) to decouple the engine (14) from the transmission (16); or
a seventh mode wherein the actuator (48) is driven during vehicle (10) deceleration with the transmission (16) in a forward gear so as to modulate the clutch (18) to decouple the engine (14) from the transmission (16),
said controller (46) being movable between said modes in response to predetermined changes in one or more of: engine speed, engine load, vehicle speed, transmission gear, or clutch pedal position.

8. The control system (44) as set forth in claim 7, wherein the vehicle (10) further includes a plurality of sensors, and
wherein said controller (46) is in electrical communication with the sensors, is responsive to signals from the sensors, and is movable between said modes in response to predetermined changes in the signals.

9. The control system (44) as set forth in claim 7, wherein the vehicle (10) has a slave cylinder (34) in communication with the clutch (18) for modulating the engagement between the transmission (16) and the engine (14); a master cylinder (36) in fluid communication with the slave cylinder (34) and operatively attached to the clutch pedal (26); and wherein the actuator (48) is further defined as a hydraulic system having a pump (50) for generating hydraulic pressure and a valve (52) in fluid communication with the slave cylinder (34) and the pump (50), and
wherein said controller (46) moves to said first mode in response to a predetermined pressure differential occurring between the hydraulic pump (50) and the master cylinder (36).

10. The control system (44) as set forth in claim 7, further including an engine control unit (22) in electrical communication with the engine (14), said controller (46) being integrated with said engine control unit (22).

11. The control system (44) as set forth in claim 7, wherein said controller (46) moves from said second mode to said third mode in response to the engine (14) reaching a predetermined speed.

12. The control system (44) as set forth in claim 7, wherein said controller (46) moves from said third mode to said fourth mode in response to the transmission (16) moving from a neutral position to a forward gear.

13. The control system (44) as set forth in claim 7, wherein said controller (46) moves to the sixth mode in response to a predetermine change in one or more of: vehicle speed, engine speed, or engine load.

14. The control system (44) as set forth in claim 7, wherein said controller (46) moves to the seventh mode in response to a predetermine change in one or more of: vehicle speed, engine speed, or engine load.

15. A control system (44) for use in modulating a clutch (18) of a manual transmission (16) in a vehicle (10), wherein the vehicle (10) has an engine (14) in selective rotational communication with the transmission (16); a clutch pedal (26) in communication with the clutch (18) and movable by a vehicle (10) operator for selectively modulating the engagement between the transmission (16) and the engine (14); an actuator (48) in communication with the clutch (18) for modulating the engagement between the transmission (16) and the engine (14) independent of the clutch pedal (26); and an authority level control adapted to be triggered vehicle (10) operator, said control system (44) comprising:
a controller (46) in communication with the actuator (48) for driving the same, said controller (46) being operable at:
authority level zero, wherein said controller (46) operates in:
a first mode wherein the actuator (48) is driven such that the clutch pedal (26) alone modulates the clutch (18),
authority level one, wherein said controller (46) operates in one or more of:
a second mode wherein the actuator (48) is driven from engine (14) startup so as to modulate the clutch (18) to decouple the engine (14) from the transmission (16);
a third mode wherein the actuator (48) is driven during engine (14) idle with the vehicle (10) stopped so as to modulate the clutch (18) to decouple the engine (14) from the transmission (16);
a fourth mode wherein the actuator (48) is driven from engine (14) idle, with the vehicle (10) stopped, and with the transmission (16) in a forward gear so as modulate the clutch (18) at a predetermined rate to simultaneously couple the engine (14) to the transmission (16), prevent the engine (14) from stalling, and prevent the vehicle (10) from reversing; or
a fifth mode wherein the actuator (48) is driven from engine (14) idle, with the vehicle (10) stopped, with the transmission (16) in a forward gear, and during acceleration so as to modulate the clutch (18) at a predetermined rate to simultaneously couple the engine (14) to the transmission (16) and prevent the engine (14) from stalling,
authority level two, wherein said controller (46) operates in one or more of:
a sixth mode wherein the actuator (48) is driven during vehicle (10) movement with the transmission (16) in a forward gear so as to modulate the clutch (18) to decouple the engine (14) from the transmission (16); or
a seventh mode wherein the actuator (48) is driven during vehicle (10) deceleration with the transmission (16) in a forward gear so as to modulate the clutch (18) to decouple the engine (14) from the transmission (16), and
authority level three, wherein said controller (46) operates in one or more of:
said first mode;
said sixth mode; or
said seventh mode,
said controller (46) being movable between said authority levels in response to one of:
changes to the authority level control, and
predetermined changes in one or more of: engine (14) speed, engine (14) load, vehicle (10) speed, transmission (16) gear, or clutch pedal (26) position.
